(19) United States
(12) Patent Application Publication
(10) Pub. No.: US 2026/0169429 A1
(43) Pub. Date: Jun. 18, 2026

(54) STEPPED PALLET FOR AN ESCAPEMENT MECHANISM

(71) Applicant: ETA SA Manufacture Horlogère Suisse, Grenchen (CH)

(72) Inventors: Pascal WINKLER, St-Blaise (CH); Dominique LECHOT, Les Reussilles (CH); Jean-Jacques BORN, Morges (CH); Gianni DI DOMENICO, Neuchâtel (CH); Mohammad Hussein KAHROBAIYAN, Boudevilliers (CH)

(73) Assignee: ETA SA Manufacture Horlogère Suisse, Grenchen (CH)

(21) Appl. No.: 19/387,949

(22) Filed: Nov. 13, 2025

(30) Foreign Application Priority Data
Dec. 18, 2024 (EP) 24221243.9

(51) Int. Cl. G04B 15/14; G04B 17/32

(52) U.S. Cl. CPC G04B 15/14; G04B 17/32

(57) ABSTRACT

A pallet (21) for a horology escapement mechanism (50), the pallet (21) including a fork (22) designed to engage with an ellipse (23) on a balance (35), an entry arm (11) and an exit arm (12) designed to engage with an escapement mobile (30), as well as an arbor (5) on which the fork (22), the entry arm (11) and the exit arm (12) are fitted, the fork (22), the entry arm (11) and the exit arm (12) being arranged on the arbor (5) in two separate parts, the fork (22) being arranged on a first level and the entry arm (11) and exit arm (12) being arranged on a second level of the arbor (5), the two levels being separated along the axis of the arbor (5) by a predetermined distance (D0).

### CROSS REFERENCE TO RELATED APPLICATION

This application claims priority to European Patent Application No. 24221243.9 filed Dec. 18, 2024, the entire contents of which are incorporated herein by reference.

### TECHNICAL FIELD OF THE INVENTION

The present invention relates to a stepped pallet for a watch escapement mechanism, as well as an escapement mechanism and a horology movement comprising such a pallet.

### TECHNOLOGICAL BACKGROUND

In most mechanical watches, the energy required to rotate the hands (for example, the minute and hour hands) is accumulated in a barrel, then dispensed by a sprung balance system, which comprises a flywheel called a balance, combined with a spring in the form of a strip wound into a spiral, called a balance spring

At an inner end, the balance spring is attached to an arbor that rotates with the balance; at an outer end, the balance spring is attached to a balance spring stud fitted on a stud holder, which is itself attached to a fixed bar (or cock).

The rotation of the balance is maintained—and its oscillations counted—by an escapement mechanism comprising a pallet driven by a low amplitude oscillating movement, provided with two or three pallet stones that engage the teeth of an escapement mobile. When thus engaged, the escapement mobile is forced into a step-by-step rotational movement at a frequency determined by the oscillation frequency of the pallet, which is itself set to the oscillation frequency of the sprung balance.

With a conventional escapement mechanism, the oscillation frequency is around 4 Hz, or approximately 28,800 vibrations per hour (A/h). Good horologists aim to ensure that the sprung balance. oscillates isochronously and steadily (meaning that the rate remains constant).

The pallet in the escapement mechanism is designed to provide a mechanical link between the balance and the escapement mobile. The positioning of the pallet is therefore important to ensure that it engages correctly with the other two components.

Generally, the pallet is formed by a monobloc body comprising a fork engaging with an ellipse on the balance and at least two arms, each often fitted with a pallet stone, engaging with the escapement mobile. The body of the pallet is fitted on an arbor comprising a pivot at each end. During assembly, the pivots are inserted into bearings arranged in the bars or the plate.

Today, the balance spring can be replaced with a flexible guide as the spring part to form a virtual pivot. Flexible guides with virtual pivots make it possible to significantly improve horology resonators. The simplest are cross-blade pivots, consisting of two guides with straight crossed blades. These two blades can be either three-dimensional in two different planes or two-dimensional in the same plane, in which case they are soldered together at their crossing point. But there are also RCC (Remote Center Compliance) guides with uncrossed blades, which have straight blades that do not cross. Such a resonator is described in documents EP14199039, and EP16155039.

However, with such a flexible guide, the balance has a much smaller amplitude, the angle of rotation being around twenty degrees, whereas with a balance spring the angle of rotation is 330°, and the balance oscillates with a much higher frequency than that of a balance fitted on a balance spring.

New escapement mechanism configurations have therefore been invented to function with a regulating organ with a flexible guide.

In most mechanical movements, the escapement wheel arbor, the pallet arbor and the sprung balance arbor are in the same plane. Seen from above, the position of these three axes forms a straight line. This is known as inline centring. However, this arrangement is quite cumbersome.

In certain horology movement configurations, the positions of the three axes form a bend. In other words, the escapement mobile, the pallet and the balance are not aligned, but are triangularly arranged, each at the top of the same triangle. Such an arrangement makes it possible to reduce the size of the horology movement.

Generally, the pallet fork and the pallet stones on the pallet are located at the same level in the movement. Moreover, as the fork engages the ellipse on the balance and the pallet stones engage the teeth on the escapement wheel, the fork and the pallet stones must be kept away from each other so that there is no collision between the ellipse and the teeth on the escapement wheel. The above explains why inline “centring” is generally used.

So on one hand, the relative position, in particular the centre distance, between the pallet and the escapement wheel must be well defined. On the other hand, the relative position, in particular the centre distance, between the pallet and the balance must also be well defined.

As the pallet stones and fork generally belong to the same part (the pallet) and engage substantially on the same level, it is difficult to meet both requirements simultaneously.

### SUMMARY OF THE INVENTION

The present invention aims to provide a pallet for a new type of escapement mechanism, one that avoids the aforementioned defects and in particular that facilitates its assembly and its engagement with the escapement mobile and the balance.

To this end, the invention relates to pallet for a horology escapement mechanism, the pallet comprising a fork designed to engage with an ellipse on a balance, an entry arm and an exit arm designed to engage with an escapement mobile, and an arbor on which the pallet is fitted, characterised in that the pallet is arranged on the arbor in two separate parts such that the fork is arranged on a first level and the entry and exit arms are arranged on a second level, the two levels being separated along the axis of the arbor by a predetermined distance.

The invention is remarkable in that the fork, the entry arm and the exit arm are arranged on the arbor in two separate parts, such that the fork is arranged on a first level and the arms are arranged on a second level, the two levels being separated along the arbor axis by a predetermined distance.

Such a pallet thus makes it possible to arrange the balance and the escapement mobile on different levels in the horology movement. For example, the escapement mobile can be arranged above the plate at the bottom of the movement and the balance arranged at the top of the movement. The stepped pallet makes it possible to engage with the balance and the escapement mobile in such an arrangement, particularly when the pallet, the balance and the escapement wheel are in a compact configuration.

According to a particular embodiment of the invention, the first level is arranged at a lower end of the arbor.

According to a particular embodiment of the invention, the predetermined distance is comprised between one quarter and three quarters of the length of the arbor, preferably between one third and three thirds of the length of the arbor, or even substantially half the length of the arbor.

According to a particular embodiment of the invention, the second level is arranged substantially in the middle of the arbor.

According to a particular embodiment of the invention, the pallet comprises a fork for engaging with an ellipse on the balance, an entry arm and an exit arm designed to engage with the escapement mobile.

The invention also relates to an escapement mechanism comprising an escapement mobile and such a pallet.

The invention also relates to a horology movement comprising a plate, a balance, a balance cock, a flexible guide, the balance being suspended by the flexible guide and such an escapement mechanism, the pallet engaging with an ellipse on the balance on one hand and with the escapement mobile on the other hand.

According to a particular embodiment of the invention, the arbor on the pallet is fitted so as to pivot in the horology movement, the arbor comprising a first pivot arranged at a first end of the arbor, and a second pivot arranged at a second end of the arbor.

According to a particular embodiment of the invention, the first pivot is fitted so as to pivot in the plate.

According to a particular embodiment of the invention, the second pivot is fitted so as to pivot in the balance cock.

According to a particular embodiment of the invention, the balance, the escapement mobile and the pallet are arranged so that a line running through the centre of the escapement mobile, the centre of the balance and the arbor on the pallet forms a bend with an angle of less than 90°, preferably less than 70° or even less than 60°.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a schematic top view of a horology module comprising a regulating organ and an escapement mechanism,

FIG. 2 is a schematic side view of the horology module in FIG. 1,

FIG. 3 is a schematic cross-sectional view of a horology movement comprising the horology module in FIGS. 1 and 2, and

FIG. 4 is a schematic perspective view of the pallet according to the invention.

### DETAILED DESCRIPTION OF THE INVENTION

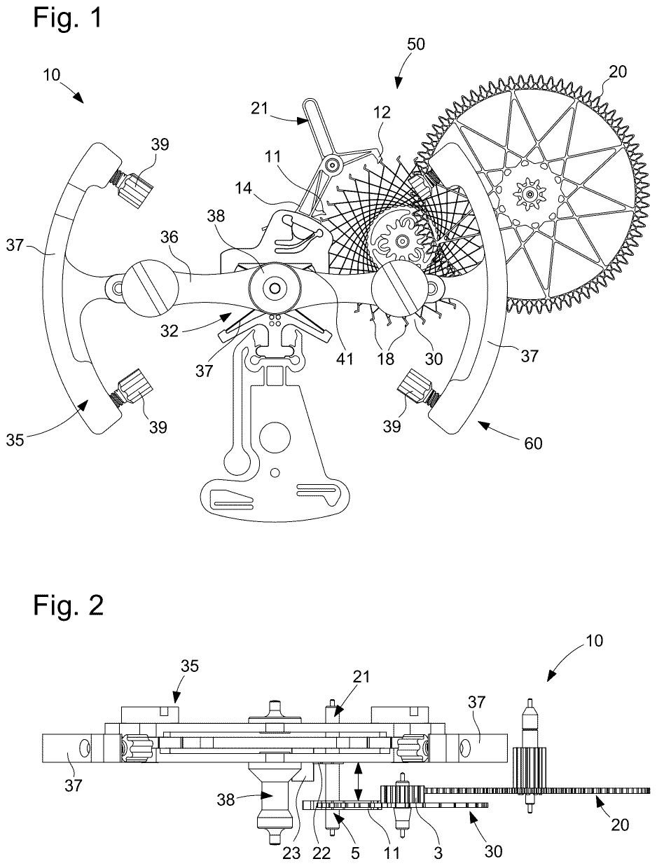

In FIGS. 1 and 2, the horology module 10 comprises an escapement mechanism 50 associated with a regulating organ 60.

The regulating organ 60 comprises a balance 35, and a rotational flexible guide 32 for the balance 35, while the escapement mechanism 50 comprises an escapement mobile 30 and a pallet 21.

The balance 35 is shaped like a bone fitted with a longitudinal portion 36 and with a lateral portion 37 in the form of a circular arc at each end of the longitudinal portion 36. The balance 35 further comprises stops concentric with the virtual axis of rotation fitted in the middle of the longitudinal portion 36 and screws 39 for setting the inertia of the balance arranged in the lateral portions 37.

The balance 35 is fitted on the flexible guide 32 to enable it to perform a rotational oscillatory movement around a virtual axis of rotation. The flexible guide 32 is directly connected to the balance 35.

The flexible guide 32 comprises at least two flexible blades 37, in this example two pairs of crossed flexible blades 37, arranged in series and forming a double pivot to increase the angle of rotation of the balance 35.

The pallet 21 is fitted with two arms 11, 12, with the ends forming two pallet stones engaging with the teeth 18 on the first escapement mobile 30.

The arms 11, 12 on the pallet 21 engage with the escapement mobile 30 and alternately interact with the teeth 18 on the escapement mobile 30 to regulate the rate.

The pallet 21 also comprises a longitudinal part 14 that extends laterally and is fitted with a fork 22 at its end to engage with an ellipse 23 on a balance 35.

The pallet 21 comprises an arbor 5 substantially perpendicular to the longitudinal part 14 and to the fork 22, and which enables it to be fitted so as to rotate in the movement.

The pallet 21 comprises a radially extending elongate body 31, said body 31 being arranged to engage with stops, not shown in the figures. The purpose of the stops is to keep the pallet 21 from rotating too much.

The elongate body 31 is arranged substantially at the level of the entry 11 and exit 12 arms on the pallet 21.

According to the invention, the fork 22 and the entry arm 11 and exit arm 12 are arranged in two parts on the arbor 5. The fork 22 is arranged on a first level of the arbor 5 while the entry arm 11 and exit arm 12 are arranged on a second level of the arbor 5.

In this way, the two levels are separated along the axis of the arbor 5 by a predetermined distance D0. Preferably, the predetermined distance D0 is comprised between one quarter and three quarters of the length of the arbor, preferably between one third and three thirds of the length of the arbor, or even substantially half the length of the arbor.

For example, the first level is arranged substantially at a lower end of the arbor while the second level is arranged substantially in the middle of the arbor.

Preferably, the arbor 5 has a length corresponding substantially to the height of the horology movement, starting from the plate 2.

The escapement mechanism 50 further comprises a second horology mobile, the second horology mobile 20 meshing with the first escapement mobile 30. For example, the second horology mobile 20 is a seconds mobile. The teeth 14 on the second horology mobile 20 mesh with a pinion 3 on the first escapement mobile 30.

The balance 35 comprises an ellipse 23 extending under the balance 35 to engage with the fork 22 on the pallet 21. The ellipse 23 is attached to the balance 35.

The centre of the balance 35, the escapement mobile 30 and the pallet 21 are arranged on a line forming a bend. This is in contrast to conventional escapement mechanisms, in which this line is substantially straight and in which the pallet is arranged on this line between the balance and the escapement mobile.

The balance 35, the escapement mobile 30 and the pallet 21 are therefore each arranged at the top of a triangle.

The bend has an angle of less than 90°, preferably less than 70° or even less than 60°. The balance 35, the escapement mobile 30 and the pallet 21 are therefore compactly arranged.

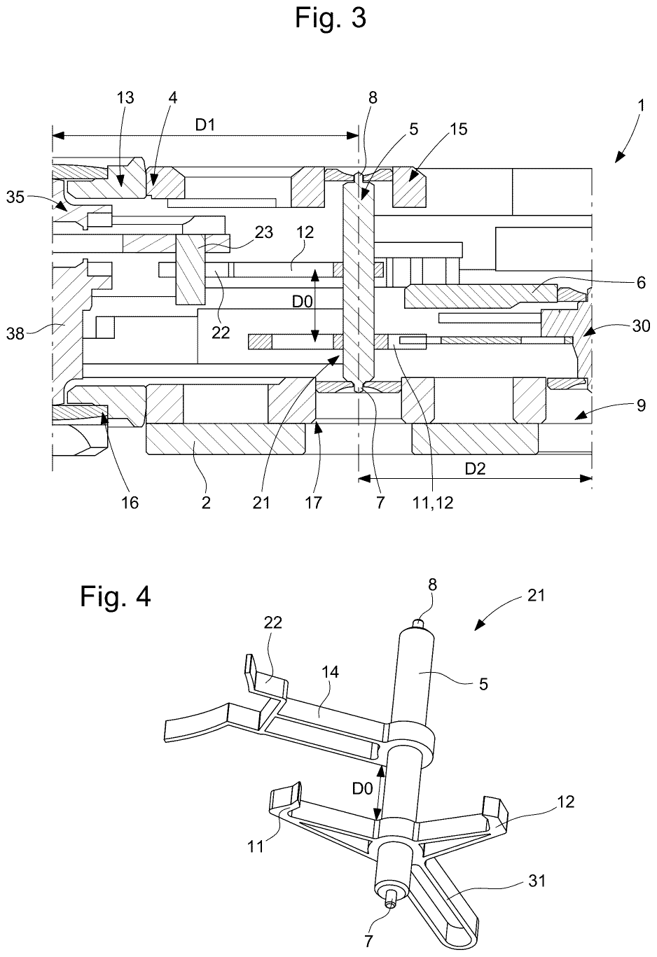

In FIG. 3, the horology module in FIGS. 1 and 2 is arranged in a horology movement 1, in particular for a watch.

In addition to the horology module 10, the horology movement 1 comprises a plate 2 and bars for supporting the components in the horology module 10.

In particular, the horology movement 1 comprises a balance cock 4 arranged above the balance 4. The balance 4 therefore oscillates between the plate 2 and the balance cock 4. For example, the balance cock 4 comprises an upper stop to secure the balance 35 vertically.

The horology movement 1 also comprises an escapement bar 6 to keep the axis on the escapement mobile 30 pivoting.

The escapement mobile 30 is fitted so as to pivot between the plate 2 and the escapement bar 6.

The arbor 5 comprises a first pivot 7 arranged at a first end of the arbor 5 and a second pivot 8 arranged at a second end of the arbor 5.

The first pivot 7 is fitted so as to pivot on the plate 2, and the second pivot 8 is fitted so as to pivot in the balance cock 4. The pallet 21 is thus fitted so as to pivot between the balance cock 4 and the plate 2. And the arbor 5 extends beyond the balance 35.

To this end, the balance cock 6 comprises a first bearing 13, which acts as a stop for the balance 37 in the event of a shock and is concentric with the virtual axis of rotation defined by the flexible guide 32, and a second bearing 15 for the pallet 21. The distance D1 between the centre of the first bearing 13 and the centre of the second bearing 15 is predetermined to enable optimum engagement between the fork 22 on the pallet 21 and the ellipse 23 on the balance 6.

The plate 2 comprises a third bearing 16 for the balance 35, a fourth bearing 17 for the arbor 5 on the pallet 21, and a fifth bearing 9 for the escapement mobile 30. The distance D2 between the centre of the fourth bearing 17 and the centre of the fifth bearing 19 is predetermined to enable optimum engagement between the arms 11, 12 on the pallet 21 and the escapement mobile 30.

The escapement bar 6 comprises a sixth bearing 24 for a pivot on the escapement mobile 30.

This arrangement of the pallet 21 better ensures the engagement between the arms 11, 12 on the pallet 21 and the escapement mobile 30 on one hand, and the engagement between the fork 22 and the ellipse 23 on the other hand. Indeed, the arbor 5 is unlikely to be too inclined relative to the plate 2.

Since the pallet 21 and the balance 35 are arranged between the plate 2 and the balance cock 4, the distance D1 of the centre distance defined between the second pivot 8 on the balance 35 and that of the pallet 21 on the balance cock 4 is constant and is unlikely to vary during assembly.

Similarly, the distance D2 of the centre distance defined between the first pivot 7 on the pallet and the pivot on the escapement mobile 30 on the plate 2 is constant and does not vary during assembly.

Naturally, the invention is not limited to the embodiments described with reference to the figures, and variants could be envisaged without departing from the scope of the invention.

1. A pallet for a horology escapement mechanism, the pallet comprising a fork designed to engage with an ellipse on a balance, an entry arm and an exit arm designed to engage with an escapement mobile, as well as an arbor on which the fork, the entry arm and the exit arm are fitted, wherein the fork, the entry arm and the exit arm are arranged on the arbor in two separate parts, the fork being arranged on a first level, and the arms being arranged on a second level of the arbor, the two levels being separated along the axis of the arbor by a predetermined distance.

2. The pallet according to claim 1, wherein the first level is arranged at a lower end of the arbor.

3. The pallet according to claim 1, wherein the predetermined distance is comprised between one quarter and three quarters of the length of the arbor, preferably between one third and three thirds of the length of the arbor, or even substantially half the length of the arbor.

4. The pallet according to claim 1, wherein the second level is arranged substantially in the middle of the arbor.

5. An escapement mechanism comprising an escapement mobile and a pallet according to claim 1.

6. A horology movement comprising a plate, a balance, a balance cock, a flexible guide, the balance being suspended by the flexible guide, so that it can oscillate around a virtual axis between the plate and the balance cock, wherein the horology movement further comprises an escapement mechanism according to claim 5, the pallet engaging with an ellipse on the balance on one hand, and with the escapement mobile on the other hand.

7. The horology movement according to claim 6, wherein the arbor on the pallet is fitted so as to pivot in the horology movement, the arbor comprising a first pivot arranged at a first end of the arbor, and a second pivot arranged at a second end of the arbor.

8. The horology movement according to claim 7, wherein the first pivot is fitted so as to pivot in the plate.

9. The horology movement according to claim 7, wherein the second pivot is fitted so as to pivot in the balance cock.

10. The horology movement according to claim 1, wherein the balance, the escapement mobile and the pallet are arranged so that a line running through the centre of the escapement mobile, the centre of the balance and the arbor on the pallet forms a bend with an angle of less than 90°, preferably less than 70° or even less than 60°.
